(19) United States
(12) Patent Application Publication
(10) Pub. No.: US 2004/0010510 A1
(43) Pub. Date: Jan. 15, 2004

(54) Method and system for database synchronization

(76) Inventor: Timo Hotti, Lohja (FI)

Correspondence Address: YOUNG & THOMPSON, 745 SOUTH 23RD STREET 2ND FLOOR, ARLINGTON, VA, 22202

(21) Appl. No.: 10/191,114

(22) Filed: Jul. 10, 2002

(51) Int. Cl. G06F 17/30

(52) U.S. Cl. 707/103 R

(57) ABSTRACT

The invention relates to a method, arrangement and content router node for database synchronization. Especially the invention relates to synchronization messaging using a content routing mechanism. In particular the invention relates to content routing where data elements are delivered between master and replica databases through a number of content router nodes. The content router node receives the data elements and decides next recipient of the data elements based on the data element and routing information of the current content router node or any of the route's previous content router nodes or the originating database. The content router node may also be arranged to wait a specified wait time for other data elements whose next destination address is the same node as that of the received data elements and if the addresses are same, the content router node aggregates the received data elements into one message.

### TECHNICAL FIELD OF THE INVENTION

The invention relates to a method and an arrangement for database synchronization. Especially the invention relates to synchronizing databases using content routing mechanism.

### BACKGROUND OF THE INVENTION

The following notions are used in this application:

“Content Router” is a node in the network through which a package of data is transferred from a source node to the target node such as database server. Especially the content router is an edge or core content router. A core router exchanges data with other routers only whereas edge router may interface both with other routers (edge or core) and with source and/or target nodes. In some embodiments, a content router node may also contain database management and synchronization functionality that makes it capable of acting as a database server.

“Data element” is an information structure, which can comprise other data elements or such data elements, which can be construed as atomary data elements. For instance, in a relational database data elements are represented by tables comprising rows. The rows comprise columns, which are typically atomary data elements. In this document, data element may also mean a package of data that has been assembled in one computing node, such as database server or content router, for transfer to another computing node.

“Database” is an information structure, which comprises one or more data elements, and the use of which is controlled by a database management system The invention is applicable both in relational databases and in databases of other forms, such as in object oriented databases

“Database Server” is a software process that manages the data of at least one database and through which applications can access and modify the data of the database. Database server is often referred to also as Database Management System (DBMS) or Flow Engine master/replica database server. In some embodiments, database server may also contain functionality that makes it capable of acting as a content router node.

“Database operation” is an event, during which data elements are read from the database, during which data elements of the database are modified, during which data elements are removed from the database, or during which data elements are added to the database.

“Database Catalogue” is a logical database within a physical database instance. A physical database can manage data of multiple database catalogues. Each database catalogue can act as a master or replica database node in a database synchronization environment.

“Database Schema” is the structure of a logical database, described in a formal language supported by the database management system (DBMS). In a relational database, the schema defines the tables, the columns in each table, and the relationships between columns and tables.

“Data synchronization” is an operation where data is exchanged between at least two data stores to make at least some data elements or parts of data elements identical between data stores. In relational databases, the minimum requirement is that data of one column of one row is identical between databases as the result of the synchronization. In one known embodiment, one of the participating data stores is a master database and another one is a replica database. In this embodiment data is transferred from replica to master database by propagating Intelligent Transactions and data transfer from master to replica database is achieved by subscribing to at least one publication, [1].

“Master database” is a logical database in a database synchronization system that contains the official version of a set of possibly distributed data. The master database may have zero, one or multiple replica databases in the network.

“Network” may be any kind of wireless or wired information network. However, the network is such that it can be implemented to work in a telecommunication system, which is compliant with at least one of the following: TCP/IP, Ethernet, ATM, CDMA, GSM, HSCSD, GPRS, WCDMA, EDGE, Bluetooth, UMTS, Teldesic, Iridium, Inmarsat, WLAN, DIGI-TV, and imode.

“Network connection” is a point-to-point data communication channel over data network between two computer application programs, such as content router or database server. In an exemplary embodiment, the network connection may be established for example using TCP/IP communication protocol and sockets. Once the connection has been established, the application programs may communicate with each other using for example remote procedure calls.

“Replica database” is a logical database in a database synchronization system that contains a full or partial copy of the data of a master database.

“Publication” is a set of data in a database that has been published in master database for synchronization to one or multiple replica databases. A publication can contain parameters that are used to filter data of the publication.

“Transaction” is a plurality of database operations acting on the data elements. A transaction is an atomic operation that is completed or discarded as a whole. A transaction can also comprise further transactions.

Different kinds of information delivering and routing mechanisms are known from prior arts for routing data between parties. The known routing mechanisms that are widely used in information network are based on the network data packet type, originating address, destination address, port, priority, tag, size of the object and type of packet of data. Some prior art solutions for incorporating content routing intelligence into information network are known from a publication U.S. Pat. No. 6,216,173, where content processing and routing system is arranged to be aware of the content and requirements of data and service request, as well as the capabilities of all services accessible via the system. The routing system according to the document considers the capabilities of the available transmission channels and the transmission needs of all current transmission service requests in order to accomplish efficient network routing.

In addition a mesh-based content routing system is known from a prior art document [2], where data streams to be delivered are comprised of a sequence of XML packets and forwarded by application-level XML routers, which perform content-based routing of individual XML packets to other routers or clients based upon queries that describe the information needs of downstream nodes. The mesh-based content routing system of document [2] uses a diversity control protocol that reassembles a received stream of packets from one or more senders using the first copy of a packet to arrive from any sender.

In the area of data synchronization, there are numerous methods and systems known in prior art. One such method is described in document [1]. There are, however, some disadvantages in the prior art solutions for example when a database node has to synchronize its data with very large number of other database nodes, e.g. in the range of ten thousands to millions of databases, in a near real-time manner

According to prior art methods, data synchronization can happen either in a connection-based or connectionless manner. In a connection-based synchronization (FIG. 1), there needs to be a direct connection between master and replica databases when the synchronization happens. This approach allows complete control, including error handling, over the synchronization process but it suffers, however, from the large number of concurrent connections between databases. Establishing and maintaining a network connection between master and replica databases is generally considered as an expensive task for a computer device. Thus for example data synchronization between large numbers of nodes, where the amount of data to be synchronized with one node is often relatively small, is very ineffective because the cost of connection management far exceeds the cost of data transfer. Generally, sending small messages across the network is less efficient than sending large messages.

Alternatively, the synchronization messages may be sent between databases in a connectionless manner (e.g. using e-mail protocol), but this approach produces a very large number of small messages and the delivery of messages is not guaranteed by the protocol. Neither do these protocols provide any means for monitoring or controlling the delivery time of the messages. These characteristics of the e-mail and other connectionless data transfer protocols make the management of the synchronization process potentially difficult.

### SUMMARY OF THE INVENTION

The object of the invention is to optimize performance and scalability of connection-based data synchronization in distributed database systems where the number of participating database nodes (masters and replicas) can be very large, e.g. in the range of millions of databases and reduce the number of concurrent synchronization connections in the database servers. In addition the object of the invention is to enable an effective and reliable message delivery mechanism. Further the object of the invention is to allow a database node to synchronize its data with large number of other database nodes concurrently.

The objects of the invention are fulfilled by providing a mechanism that reduces the number of concurrent synchronization connections in the database servers using a network of content routers as a means to deliver large number of typically small synchronization messages between large number of master and replica databases. In addition the objects of the invention are fulfilled by optimizing the number of the messages to be delivered through the network by aggregating multiple synchronization messages, whose next destination is the same router or database server, into one message.

A Content Router is a computer node in the network, which is capable of looking at the content of the package and determine next recipient of the package based on the information. To optimise the speed of data exchange between its peers, i.e. other routers and/or source or target of the data, the router may maintain a number of network connections between itself and some of its peers also when no data is being transmitted. The content router may be for example based on a database engine that is capable of exchanging synchronization messages with other routers or database engines.

According to the invention data may be synchronized between the master and replica databases using a content routing mechanism as a message delivery network. Such mechanism is especially beneficial in optimization of delivery of large number of typically small synchronization messages between large number of master and replica databases. The content routing mechanism is a network of edge and core content routers. Each master and replica database is connected to at least one edge content router. The edge content routers are connected advantageously to several core content routers. Edge content routers may also be connected directly to other edge content routers. The core content routers may be connected to other core content routers and possibly to a number of edge content routers. At least some of the routers and database servers of the system maintain continuous network connections between each other to avoid the costly operation of establishing the network connection when data needs to be passed between the aforementioned nodes. Continuous network connection here means that the network connection is maintained between participating nodes for at least some time even if there is no data to be transferred between the router and/or database server nodes. This arrangement makes a network of interconnected routers and database servers that is capable of passing large number of messages between the database servers in an optimised manner.

According to one embodiment of the invention each database server, so called Flow Engine database server, has a particular router node, so called Flow Edge router node, to which the Flow Engine database server sends data to be synchronized. Each Flow Edge Router can serve a moderate number (e.g. thousand) of Flow Engine servers. In addition the Flow Edge router knows of a number of Flow Core routers to which it can forward the messages it receives from its Flow Engine database servers.

When a Flow Engine database server wants to synchronize some data of at least one of its replica databases with another database server, it assembles the message and sends it to its Flow Edge router instead of sending it directly to another database server that manages the related master database. The Flow Edge Router looks up from its routing information, to which Flow Core (or Edge) Router the message must be forwarded. The Flow Edge Router or any other participating node, including the originating database server, may also calculate the entire route for the message if that is a more efficient way to determine the route. When the Flow Core router receives the message, it determines the next router node for the message, unless it has been determined earlier. This continues until the message reaches the Flow Edge Router of the database server that manages the master database. The Flow Edge router sends the message to the database server who executes the message, assembles the reply message and sends it back to its Flow Edge Router. The Flow Edge Router forwards the message further to the router network based on its routing information. Eventually the reply message finds its way to the Flow Edge Router of the database server that manages the replica database that forwards it to the database server. The synchronization round is complete when the replica database server has successfully executed the reply message. The method described above is called “pull synchronization”. The synchronization may also be initiated by the master database who sends the synchronization message to replica database for processing. Such process is called “push synchronization”.

The number of messages to be delivered through the network can be optimized aggregating multiple synchronization messages, whose next destination is the same router or database server, into one message. To allow this, each synchronization message can be specified a wait time that it may stay idle in any of the routers waiting for other messages. For example, a router can keep the message in queue for five seconds. If during that five seconds additional messages appear whose next node is the same as that of the first message, these messages are concatenated together with the first message. When the concatenated message arrives into the next flow router, the router analyses the contents of the message and determines whether the concatenated message needs to be unassembled back into smaller messages. This is necessary if the next recipients of the messages are different for each message.

The router network according to the invention may optionally guarantee persistence of each message submitted to it. To do this, for example the edge router that receives the message from the originating database server may keep the synchronization message in a persistent store. Now if the delivery of the message fails for example because of a hardware or network failure, the copy of the original message may be delivered through another route. Advantageously the copy will be kept in memory or in a persistent store until the reply message has been received from the receiver, such as database server that manages the master database. Further any of the Flow routers can be made fault tolerant using for example synchronous database replication (database mirroring) techniques, where a duplicate copy of each active message of the primary router node is stored in a redundant router node. If the primary router fails, the secondary router may take over the responsibilities of the primary node. In this case, a failure of a single computer in the system does not cause any need for re-routing of messages.

To maintain and optimize the performance of the router network, each router node may gather statistics about its performance and forwards it to the router manager node using for example data synchronization techniques such as Intelligent Transactions [1]. The router manager node analyses the statistics and updates and synchronizes the routing information of the content router nodes if needed.

It should be noted, that the Flow Edge and Core routers can be based on the same data management and messaging technology as Solid Flow Engine database server (or similar synchronization-capable relational database server), but the Flow Edge and Core routers contain additional means or application logic to implement the message routing logic. The main difference between Flow router and a Flow Engine database server is that Flow router generally does not do anything with the payload of the synchronization message. In a typical case, the Flow router just sends synchronization messages further to another router or database server according to routing information. However, the router may for performance optimisation purposes concatenate previously built messages together into large messages or de-assemble these messages when the parts of the previously concatenated message need to be routed to different recipients. The router may also encrypt or decrypt the messages it handles. Additionally, a database server may also serve a dual role: it may act as both a database server and a content router.

The methods and arrangements in accordance with the invention are especially suited for a network of content routers whose task is to act as messengers between a very large number of master and replica databases.

The invention relates to a method for data synchronization where at least one data element is delivered between at least one master and replica database through at least one content router node, where next recipient of the data element is selected in the content router node based on destination address of the data element and routing information of the current content router node or any of the route's previous content router nodes or the originating database.

The invention further relates to an arrangement for data synchronization through content routing network comprising at least one database server managing a replica database, at least one database server managing a master database and an information network comprising a number of content router nodes, wherein the arrangement further comprises means for delivering at least one data element between at least one master and replica database through a number of content router nodes and means for selecting next recipient of the data element in the content router node based on destination address of the data element and routing information of the current content router node or any of the route's previous content router nodes or the originating database.

The invention further relates to a content router node for content routing of data synchronization messages, where the content router node is arranged to deliver at least one data element between a master and replica database, and further the content router node is arranged to select next recipient of the data element based on destination address of the data element and routing information of the current content router node or any of the route's previous content router nodes or the originating database.

The best mode of the invention is considered to be assigning a Flow Edge router for each Flow Engine database server for providing a scalable method for transmitting a large number of synchronization or other messages to a large number of databases in a connection-based manner.

### BRIEF DESCRIPTION OF THE DRAWINGS

Next the invention will be described in greater detail with reference to exemplary embodiments in accordance with the accompanying drawings, in which

FIG. 1 illustrates a connection-based synchronization according to prior art,

FIG. 2a illustrates a flow diagram of an exemplary method for synchronizing of databases according to an advantageous embodiment of the invention

FIG. 2b illustrates a flow diagram of another exemplary method for synchronizing of databases according to an advantageous embodiment of the invention,

FIG. 2c illustrates a flow diagram of an exemplary method for managing router information according to an advantageous embodiment of the invention,

FIG. 3 illustrates a block diagram of an exemplary arrangement for synchronizing of databases according to an advantageous embodiment of the invention,

FIG. 4 illustrates a block diagram of an exemplary arrangement for implementing a router and routing information management system according to an advantageous embodiment of the invention, and

FIG. 5 illustrates a block diagram of an exemplary arrangement for routing information management and updating system according to an advantageous embodiment of the invention.

### DETAILED DESCRIPTION

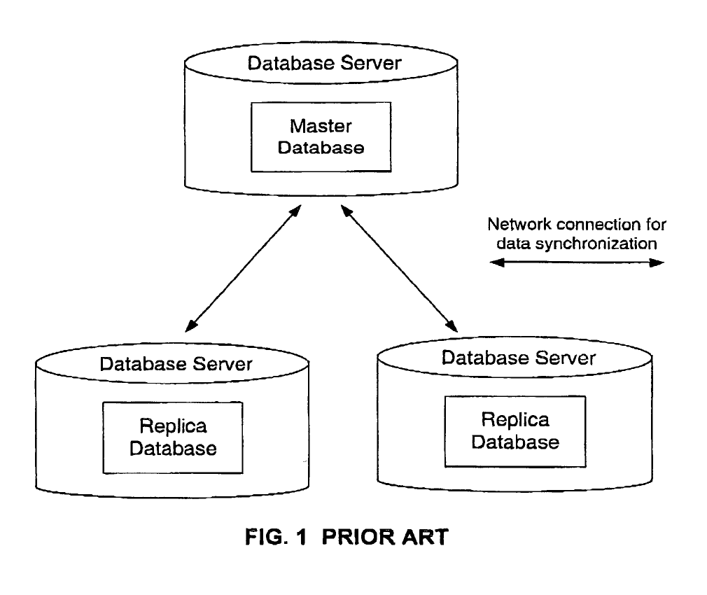

A description of FIG. 1 was given earlier in connection with the description of the state of the art.

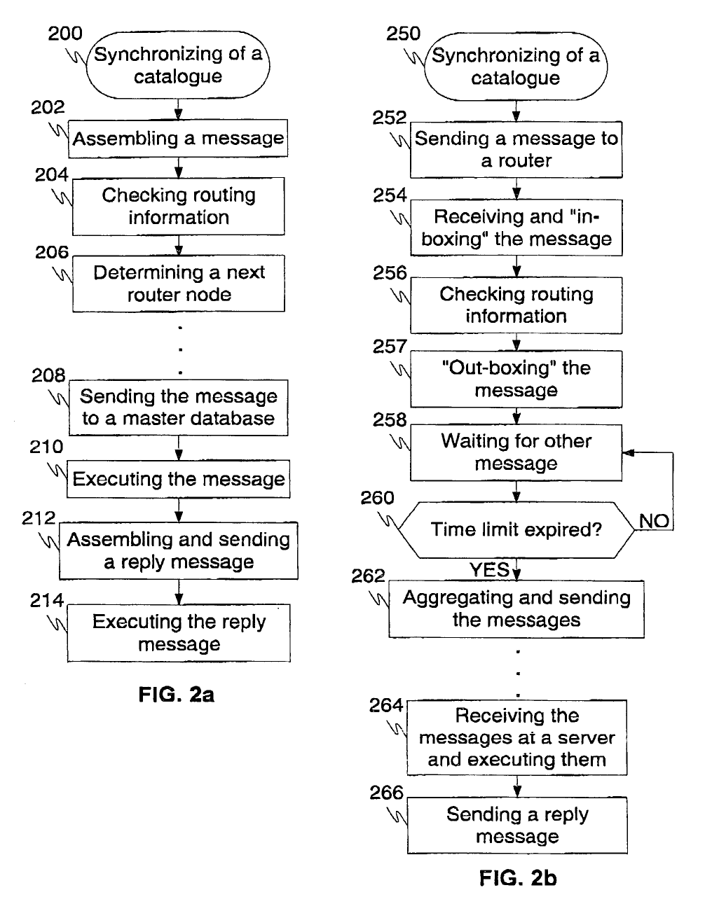

FIG. 2a illustrates a flow diagram of an exemplary method 200 for pull synchronization of databases according to an advantageous embodiment of the invention, where a Flow Engine database server wants to synchronize some data of at least one of its replica databases with another database server that manages the related master database. In step 202 the Flow Engine database server assembles the message and sends it to its Flow Edge router instead of sending it directly to another database server that manages the related master database, such as replica database server.

In step 204 the Flow Edge Router looks up from its routing information, to which Flow Core (or Edge) Router (or Flow Engine database server) the message must be forwarded. The Flow Edge Router or any other participating node may also calculate in step 204 the entire route for the message if that is a more efficient way to determine the route.

When the Flow Core router receives the message, it determines the next router node for the message in step 206, unless it has been determined earlier. This continues until the message reaches the Flow Edge Router of the database server that manages the master database. The Flow Edge router sends the message to the database server in step 208 who executes the message in step 210, assembles the reply message and sends it back to its Flow Edge Router in step 212. The Flow Edge Router forwards the message further to the router network based on its routing tables. Eventually the reply message finds its way to the Flow Edge Router of the replica database server that forwards it to the database server. The synchronization round is complete when the replica database server has successfully executed the reply message in step 214.

FIG. 2b illustrates a flow diagram of another exemplary method 250 for synchronizing of databases according to an advantageous embodiment of the invention, where an aggregating method is used and where a Flow Engine database server may synchronize at least part of its catalogues with another database server, such as Flow Engine database server that manages a master database. At first the Flow Engine database server assembles the message to be synchronized and sends the message in step 252 to a Content Router, such a Flow Edge router, which is assigned for the Flow Engine database server. In step 254 the Flow Edge router receives the message and “in-boxes” it to a separate “mail slot”. The mail slot may be specific to the sender of the message, such as Flow Engine database server. In step 256 the Flow Edge router may check the destination address of the delivered message and determine the next recipient of the message based on a routing information table, to which Flow Core Router or alternatively Flow Engine database server the message must be forwarded. In step 257 the Flow Edge router may “outbox” the received message to a mail-slot, which could be specific for a router with which this router can exchange messages. Alternatively the mail-slot may be specific also for a database server.

The Flow Edge or Core router may also decide to queue the received message for a pre-determined time in step 258 in order to allow other messages (who have same next recipient) to be aggregated into the same message. In step 260 the Flow Edge or Core router monitors the determined time limits and if it is expired the received messages (who have same next recipient) are aggregated and sent to the next Flow Core or Flow Edge router or alternatively to Flow Engine database server in step 262. Otherwise the additional messages are waited still in step 258. It should be clear for person skilled in the art that if additional messages will be received within the time limit, steps 254-257 may be performed also to those messages.

Steps 254-262 can be performed continuously at the Flow routers, such as Flow Edge or Flow Core routers. Further the Flow routers may or may not make the messages persistent in the Flow router node. For best performance, the messages may be kept in-memory, whereupon the message may remain persistent in some other node of the system (such as the originating edge router node) to guarantee reliable message transfer. In addition the Flow routers may gather statistical information about their performance and forward it to the router manager node using data synchronization techniques such as Intelligent Transactions (not shown in the flow diagram of FIG. 2b).

Finally, when the message is received at the receiving end in step 264, such as the Flow Engine database server that manages the master database, it is executed. After executing the message the receiver advantageously assemble the reply message that typically contains data from the master database and sends it back to a receiver's Flow Edge router in step 266. The Flow Edge Router forwards the message further to the router network based on its routing tables. Eventually the reply message finds its way to the Flow Edge Router of the original sender, such as a Flow Engine database server that manages the replica database. The bi-directional data synchronization round is complete when the Flow Engine database server has executed the reply message. In case of unidirectional data synchronization, the reply message is not always needed.

It should be noted that the method of the flow diagram of FIG. 2b can be applied also when the sender of the message is another party than a Flow Engine database server, such as a Flow Edge router or a Flow Core router. In addition the receiver of the message may also be a Flow Core router, a Flow Edge router or alternatively a Flow Engine database server.

FIG. 2c illustrates a flow diagram of an exemplary method 280 for managing router information according to an advantageous embodiment of the invention, where a Flow router, such as Flow Edge or Flow Core router, has a replica copy of a management database to which it may gather management data in step 282 such as statistical data of its performance and usage level and forward it to the router manager database that hosts the master copy of the management database. The router management node may advantageously interface using data synchronization with some or all Flow routers and possibly some other network nodes of the system.

Gathered statistical data is delivered in step 284 to the router manager database using data synchronization or other messaging techniques, for instance. The router manager node may advantageously receive statistical data from several Flow routers and thus have global view about the performance data of the used network or at least significant part of the network. In addition the router manager node may have knowledge of capacity and effectiveness of the Flow routers and it may also monitor the state of at least part of the Flow router network as well as condition of the nodes, which delivers the messages between the parties.

The router manager node can make also computing operations in step 286, such as statistical conclusions based on the gathered data, for the network arrangement of the invention in real time. The router manager node may compare the statistics for example to the previous routing information or to statistical data of other routers in step 288. If the routing information should be updated, the routing information tables of the master database are updated in step 290. Reason for updating the routing information tables may be for example a discovery that the used wait time is not appropriate or transferring capacity is changed between nodes. If the routing information is not needed to be updated the router manager node may continue the router information managing process by performing step 282 again.

Further the router manager node may deliver the updated data to at least part of the nodes of the network in step 292. The delivering process may be implemented using data synchronization techniques such as subscribing to a publication, for instance. Also other data transfer techniques such as messaging may be used. According to an advantageous embodiment of The invention synchronizing of the information may be carried out simultaneously to multiple replica databases.

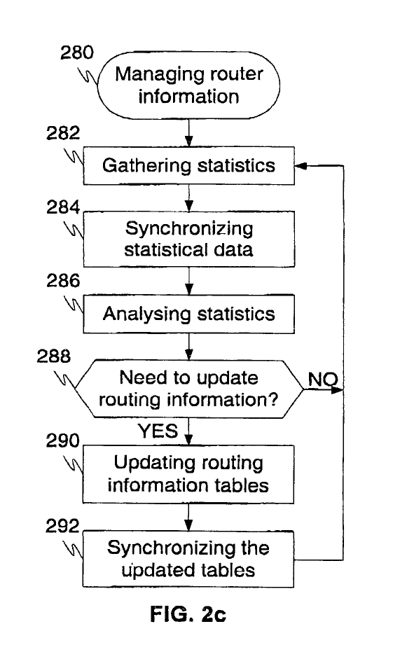

FIG. 3 illustrates a block diagram of an exemplary arrangement 300 for data synchronization by utilizing a content routing mechanism according to an advantageous embodiment of the invention, where content routing mechanism is used as a means to efficiently deliver large number of typically small synchronization messages between large number of Flow Engine database servers 302, 304 via a network of content routers 306-312.

The arrangement 300 illustrates a method, where the Flow Engine database server 302, 304 can assemble a message, and send it to its Flow Edge router 306, 312 instead of sending it directly to the recipient Flow Engine database server 302, 304.

The Flow Edge routers 306, 312, as well as the Flow Core routers 308, 310 may aggregate multiple synchronization messages, whose next destination is same router 308, 310 or Flow Engine database server 302, 304, into one message in order to minimize the number of messages travelling between nodes and thus optimise the effectiveness of the information network system. The aggregating of the messages is however optional. The Flow Edge router may also send the message directly to another Flow Edge router.

The Flow Edge and Flow Core routers 306, 308, 310, 312 may be arranged to buffer the delivered messages for a specified wait time in order to wait for some other messages, that have the same next recipient in order to aggregate them into one message and forward to the next router or database server. Advantageously, the data connection between two router nodes or router node and database server is maintained between messages. This way, the overhead of establishing the data connection for each synchronization message can be avoided.

According to one embodiment of the invention the Flow Engine database servers may maintain numbers of databases 302, 304, whereupon the servers may also be arranged to queue the messages to be delivered for a specified wait time in order to wait some other possible messages, that may have the same next recipient in order to aggregate them into same message and forward to the Flow Edge router 306, 312.

It should be noted that the arrangement illustrated in FIG. 3 is exemplary and there may be more or less Content Routers in the used information network.

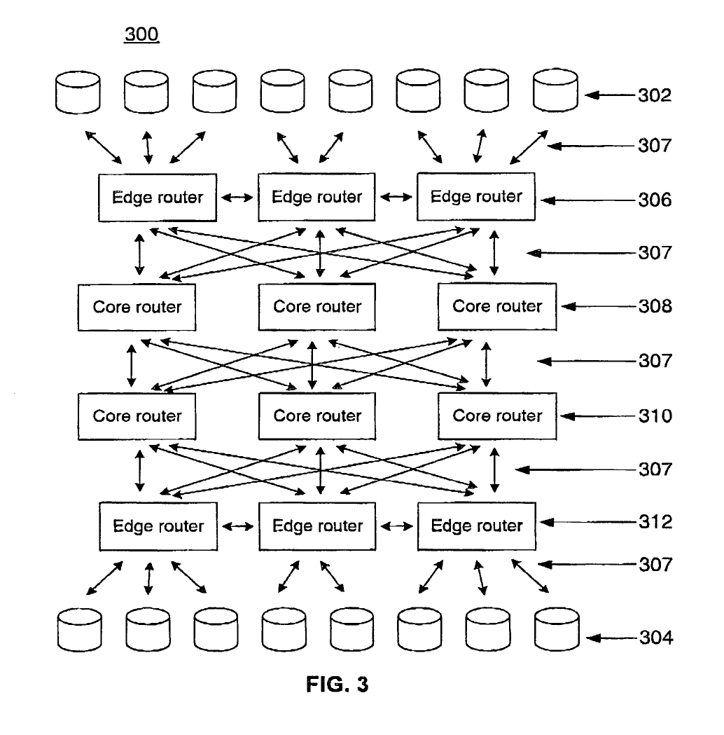

FIG. 4 illustrates a block diagram of an exemplary arrangement for implementing a Flow router 400, such as Flow Edge or Flow Core router, and routing information management system 410 according to an advantageous embodiment of the invention.

The Flow router 400 is typically a database engine that is capable of exchanging synchronization messages with other routers or database engines. The main difference between a Flow router and a Flow Engine database server is that the Flow router does not generally do anything with the payload of the synchronization message. It just sends it further to another router or database server. However, the router may for performance optimisation purposes assemble previously built messages together into large messages or de-assemble these messages if the next node of the parts of the message is different. The router may also encrypt or decrypt the messages it handles.

The Flow router 400 typically comprises a separate storage 402 for incoming messages and a separate storage 406 for outgoing messages. This storage may be persistent (disk based) or volatile (main memory based). There may be a separate “mail slot” (such as 402a, b, c, d, e, f, g) in the in-box and out-box for each router or Flow Engine database servers with which the Flow router 400 can synchronize messages. In addition the Flow router 400 comprises a “switch fabric” means 404 between the mail slots that moves the flow messages from the inbox 402 to the appropriate outbox 406. The switch fabric means may be implemented i.e. by program logic.

The Flow router 400 may also comprise a separate replica database 408 consisting for example of management information and routing information and means 409 for updating, analysing and synchronizing information. In addition the replica database 408 may comprise statistical data for example of performance of the Flow router 400. The replica database 408 may be synchronized with the separate router manager node 410, which advantageously comprises a management master database 412 of the router network.

Once the Flow router 400 receives messages, it determines the next recipient of the message based on the management information (routing tables) of its replica database 408 using means 411. The Flow router 400 has also means 414 for deciding to queue the message for a pre-determined time in order to allow other messages (who have same next recipient) to be aggregated into the message. The Flow router comprises typically also means 416 for aggregating the messages. After queuing and aggregating the messages into one message, it is forwarded to the next Flow router or alternatively Flow Engine database server. If a data connection between the current and next Flow Router does not exist, such connection is established prior to forwarding the message. After forwarding the message, the connection may be either terminated or left active, depending on the performance optimization logic of the participating nodes. Typically, frequently used connections are kept active whereas seldom used connections are terminated.

The messages may or may not be made persistent in the Flow router node and thus the Flow router 400 may comprise a memory means 418 for storing the messages in either persistent or volatile manner. For best performance, the messages may be kept in-memory 418, whereupon the message may remain persistent in some other node of the system (such as the originating edge router node) to guarantee reliable message transfer.

The Flow router 400 and the router manager node 410 may be connected to each other by data communication connection means 307 known by person skilled in the art, for instance.

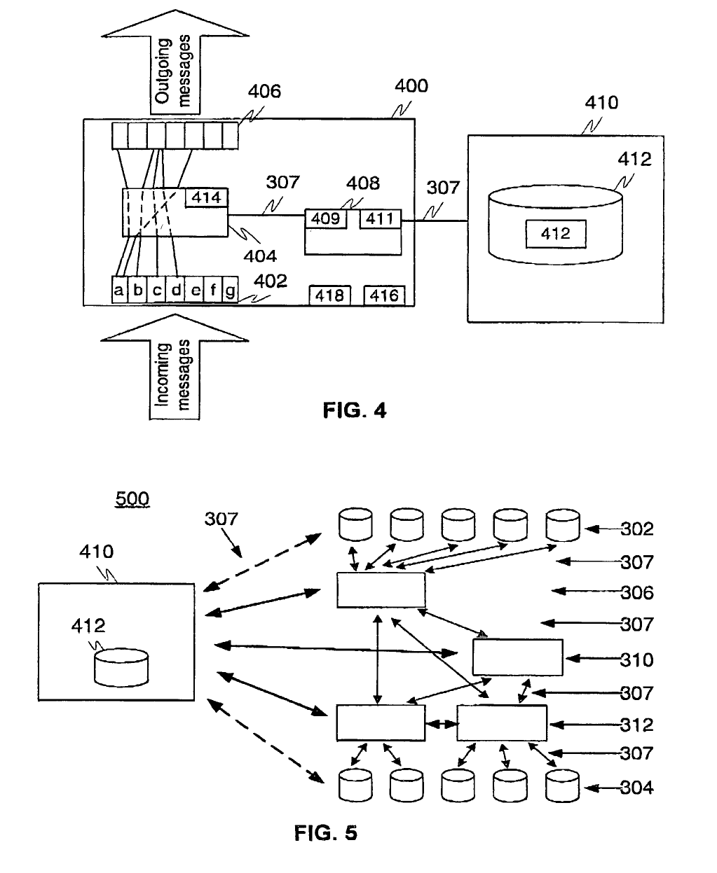

FIG. 5 illustrates a block diagram of an exemplary arrangement 500 for providing a routing information management and updating system of the whole arrangement 500 according to an advantageous embodiment of the invention. The arrangement 500 comprises at least Flow Engine master and replica databases 302, 304, Flow Edge and Core routers 306, 310, 312 and at least one router manager node 410. The routing management system of the arrangement 500 is implemented using a separate router manager node 410 that may advantageously interface at least with Flow router nodes 306, 310, 312 of the arrangement 500. Additionally, the management system 410 may interface with some or all Flow Engine master and replica databases 302, 304.

The router manager node 410 comprises typically at least one management master database 412, which includes information about statistics of router nodes and configuration information of the arrangement 500, databases and router nodes, for example. In addition the router manager node 410 may comprise also a configuration manager application for administrating, controlling and monitoring the configuration of the arrangement 500. According to the invention the router manager node 410 advantageously has a global view of the arrangement 500 either alone or together with other router manager nodes and it 400 may also monitor the state of databases and nodes 302, 304, 306, 310, 312 of at least part of the arrangement 500. Should the arrangement 500 contain more than one router manager node, these nodes may share information between each other using data synchronization or other messaging techniques (not shown in FIG. 5).

According to one embodiment of the invention the router manager node 410 may interface or synchronize routing information such as wait time limits, addresses of nearest and/or fastest router nodes, databases to which a router node is assigned, other configuration parameters and also possible application programs with at least part of nodes of the arrangement 500 in near real time. The application programs may be designed for gathering statistics and/or they may comprise additional application logic to implement the message routing logic, for example. The router manager node 410 can also make computational operations, such as statistical conclusions or alterations to routing tables, for the part of arrangement it manages. Further the router manager node 410 may synchronize information with at least part of the nodes of the arrangement 500 simultaneously. More detailed description of a router manager node or analogous configuration management system is disclosed in another US patent application [3] filed by Solid.

In addition according to one embodiment of the invention the router manager node 410 may administrate the security material of the whole arrangement 500. The router manager node 410 may for example administer certificates and public/private key pairs, which are needed for example in an authentication process of servers and in encryption process of transactions between a master and replica.

Furthermore it should be noticed that transferring data between the router manager node 410 and other parts of the arrangement 500 may be implemented using synchronization through a data communication network 307, but other methods of data transfer known by a person skilled in the art can be applied as well. Further it should be noticed that transactions or other delivered data may be encrypted for example using disposable keys assigned by the master according to the method disclosed in another US patent application [4] filed by Solid.

Furthermore it should be noted that the number of the router manager nodes 410 is essentially less than the number of the nodes, such as Flow routers 306, 310, 312 and Flow Engine database servers 302 and 304. In addition according to one embodiment of the invention the arrangement 500 may also comprise more than one router manager node 410, whereupon the router manager nodes 410 are advantageously arranged to operate together and connected with each other using a data communication network.

The used information network 307 (illustrated in FIGS. 3, 4 and 5) may for example be wired or wireless information network and it can be implemented to work in a telecommunication system, which is compliant with at least one of the following: TCP/IP, Ethernet, CDMA, GSM, HSCSD, GPRS, WCDMA, EDGE, Bluetooth, UMTS, Teldesic, Iridium, Inmarsat, WLAN, DIGI-TV, and imode.

It is also preferable to use a standardized operating system in the devices, such as those servers, routers, other devices and terminals, which administer the master and replica databases and router management information databases in the information network 307. The operating system of devices may be, for example, Unix, MS-Windows, EPOC, Symbian, NT, MSCE, Linux, VxWorks, ChorusOS, PalmOS, Elate, NetBSD, FreeBSD, OSE, QNX and GEOS.

Several advantages of the inventive method and system have been demonstrated and it is clear that it realizes several application opportunities in accordance with the invention. For example the master and replica databases according to the present invention can be managed by any data processing device known by a person skilled in the art, such as for example a computer, a workstation or a mobile station equipped with a suitable means for connecting to the information network. In addition the devices may comprise at least one processor and memory means.

A system according to the invention can be implemented by a person skilled in the art with state of the art of information technology and communication technology components. A person skilled in the art can implement the functions according to the invention by arranging and programming such components to realize the inventive functions.

To a person skilled in the art it is obvious that in order to have an illustrative description the above presented exemplary embodiments have a structure and a function, which are relatively simple. By applying the model presented in this application it is possible to design different and very complicated systems, which in obvious ways to the expert, utilize the inventive idea presented in this application.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

### CITED DOCUMENT

[1] EP 0 860788; Intelligent Transaction, Solid Information Technology Oy

[2] Mesh-Based Content Routing using XML, Alex C. Snoeren, Kenneth Conley, and David K. Gifford, MIT Laboratory for Computer Science; 18^{th} ACM Symposium on Operating System Principles, 2001

[3]U.S. Ser. No. 09/851,478; Method and Arrangement for the Management of Database Schemas, Solid Information Technology Oy

[4] U.S. Ser. No. 09/846,107; Method and arrangement for secure synchronized transactions, Solid Information Technology Oy

1. A method for data synchronization, characterized in that at least one data element is delivered between at least one master and replica database through at least one content router node, where next recipient of the data element is selected in the content router node based on destination address of the data element and routing information of the current content router node or any of the route's previous content router nodes or the originating database.

2. A method according to claim 1, characterized in that at least one second data element, whose next destination address is the same node as that of said data element is aggregated into one message with said data element.

3. A method according to claim 1, characterized in that said content router node is at least one of the following: edge router, core router, database server managing at least one master database and database server managing at least one replica database.

4. A method according to claim 3, characterized in that said database servers have at least one specific edge router, through which the servers transmit data elements.

5. A method according to claim 3, characterized in that said edge router node serves a number of database servers.

6. A method according to claim 3, characterized in that said edge router node has information of a number of core routers and/or other edge routers to which said edge router can forward the messages it receives from its database server.

7. A method according to claim 3, characterized in that said node maintains a data communication connection with at least one other content router or database server node also during periods when no data is transmitted between the nodes.

8. A method according to claim 2, characterized in that a wait time is specified for said node that it may stay idle after receiving the first data element for waiting other data elements to be aggregated with the first element, if next node of the other data elements is the same as that of the first data element.

9. A method according to claim 1, characterized in that at least one router node keeps the data element to be delivered in a persistent store until the data element has been successfully processed by the recipient database server.

10. A method according to claim 1, characterized in that delivered data between the database nodes is encrypted using at least one disposable key assigned by the receiving database.

11. A method according to claim 1, characterized in that management information about said router node is gathered into a local replica database and synchronized with a master database of a separate router manager node.

12. A method according to claim 11, characterized in that said router manager node analyses and summarizes management information of said router nodes and updates routing information of at least one router node based on the analysed management information.

13. A method according to claim 1, characterized in that configuration of said routing information of the content router nodes is managed by a separate router manager node, which has a global view of at least part of the network arrangement.

14. A method according to claim 1, characterized in that gathering and analysing of statistics and updating of routing information is performed in near real time.

15. A method according to claim 1, characterized in that the master database executes the received synchronization message and assembles the reply message to be delivered to the replica database.

16. A method according to claim 1, characterized in that the method is compatible with at least one of the following communication specifications: TCP/IP, Ethernet, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

17. A method according to claim 1, characterized in that at least one of the following operating systems is used in at least one node: Unix, MS-Windows, Symbian, VxWorks, OSE, QNX, Linux, PalmOS and GEOS.

18. An arrangement for data synchronization through content routing network, characterized in that the arrangement comprises at least one database server managing a replica database, at least one database server managing a master database and an information network comprising a number of content router nodes, wherein the arrangement further comprises means for delivering at least one data element between at least one master and replica database through a number of content router nodes and means for selecting next recipient of the data element in the content router node based on destination address of the data element and routing information of the current content router node or any of the route's previous content router nodes or the originating database.

19. An arrangement according to claim 18, characterized in that the arrangement comprises means for aggregating at least one second data element, whose next destination address is the same node as that of said first data element into one message with said first data element.

20. An arrangement according to claim 18, characterized in that the said content router node is at least one of the following: edge router, core router, database server managing at least one master database and database server managing at least one replica database.

21. An arrangement according to claim 18, characterized in that said database servers have at least one specific edge router, through which the servers transmit data elements.

22. An arrangement according to claim 20, characterized in that said edge router node is arranged to serve a number of database servers that each manage at least one database.

23. An arrangement according to claim 20, characterized in that said edge router node is arranged to be in data connection with a number of core routers and/or other edge routers to which said edge router can forward the messages it receives from its database server.

24. An arrangement according to claim 20, characterized in that said content router node is arranged to maintain a data communication connection with at least one other router or database server node also during periods when no data is transmitted between the nodes.

25. An arrangement according to claim 18, characterized in that said node is arranged to wait a specified wait time that it may stay idle after receiving the first data element for waiting other data elements and further said node is arranged to aggregate other data elements with the first element, if next node of the other data elements is the same as that of the first data element.

26. An arrangement according to claim 18, characterized in that at least one router node is arranged to keep the data element to be delivered in a persistent store until the data element has been successfully processed by the recipient database server.

27. An arrangement according to claim 18, characterized in that management information about said router node is gathered into a local replica database and synchronized with a master database of a separate router manager node.

28. An arrangement according to claim 27, characterized in that said router manager node is arranged to analyse and summarize management information of said router nodes and to update routing information of at least one router node based on the analysed management information.

29. An arrangement according to claim 18, characterized in that a separate router manager node is arranged to manage routing information of the routers, where the separate router manager node has a global view of at least part of the network arrangement.

30. An arrangement according to claim 18, characterized in that the master database is arranged to execute the received message and assemble the reply message to be delivered to the replica database through the network of router nodes.

31. An arrangement according to claim 18, characterized in that the arrangement is compatible with at least one of the following communication specifications: TCP/IP, Ethernet, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

32. An arrangement according to claim 18, characterized in that said node has at least one of the following operating systems is used in at least one node: Unix, MS-Windows, Symbian, VxWorks, OSE, QNX, Linux, PalmOS and GEOS.

33. A content router node for content routing of data synchronization messages, characterized in that the content router node is arranged to deliver at least one data element between a master and replica database, and further the content router node is arranged to select next recipient of the data element based on destination address of the data element and routing information of the current content router node or any of the route's previous content router nodes or the originating database.

34. A content router node according to claim 33, characterized in that the router node is arranged to aggregate at least one second data element, whose next destination address is the same node as that of the first data element into one message with the first data element.

35. A content router node according to claim 33, characterized in that the content router node comprises application logic to implement the message routing logic.

36. A content router node according to claim 33, characterized in that said node is at least one of the following: edge router, core router, database server managing a master database and database server managing a replica database.

37. A content router node according to claim 33, characterized in that said router node is edge router and it is arranged to be in data connection with at least one database server from which the router node receives data elements to be delivered.

38. A content router node according to claim 33, characterized in that said content router node is edge router and it is arranged to serve a number of database servers.

39. A content router node according to claim 33, characterized in that an edge router node is arranged to be in data connection with at least one core router to which said edge router can forward the messages it receives from its database servers.

40. A content router node according to claim 33, characterized in that said content router node is arranged to maintain a data communication connection with at least one other content router or database server node also during periods when no data is transmitted between the nodes.

41. A content router node according to claim 33, characterized in that said content router node is arranged to wait a specified wait time that it may stay idle after receiving the first data element for waiting other data elements and further said node is arranged to aggregate other data elements with the first element, if next node of the other data elements is the same as that of the first data element.

42. A content router node according to claim 33, characterized in that at least one content router node is arranged to keep the data element to be delivered in a persistent store until the data element has been successfully processed by the recipient database.

43. A router node according to claim 33, characterized in that said node is arranged to gather management information about said router node into a local replica database and synchronize it with a master database of a separate router manager node.

44. A content router node according to claim 33, characterized in that the content router node has a local database comprising routing information and a separate router manager node is arranged to manage the routing information of the router nodes, where the separate router manager node has a global view of at least part of the network arrangement.

45. A content router node according to claim 33, characterized in that the content router node comprises a separate storage for incoming and outgoing data elements and a program logic means for moving the flow data elements from an inbox to an appropriate outbox.

46. A content router node according to claim 33, characterized in that the content router node is compatible with at least one of the following communication specifications: TCP/IP, Ethernet, CDMA, GSM, HSCSD, GPRS, WCDMA, EDGE, Bluetooth, UMTS, Teldesic, Iridium, Inmarsat, WLAN, DIGI-TV, ISDN, xDSL, RPC, Home-PNA, and imode.

47. A content router node according to claim 33, characterized in that said content router node has at least one of the following operating systems is used in at least one node: Unix, MS-Windows, Symbian, VxWorks, OSE, QNX, Linux, PalmOS and GEOS.
